(19) United States
(12) Patent Application Publication
(10) Pub. No.: US 2009/0313691 A1
(43) Pub. Date: Dec. 17, 2009

(54) IDENTITY VERIFICATION SYSTEM APPLICABLE TO VIRTUAL PRIVATE NETWORK ARCHITECTURE AND METHOD OF THE SAME

(75) Inventor: Che-Min Chien, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: Chunghwa Telecom Co., Ltd., Taipei (TW)

(21) Appl. No.: 12/359,488

(22) Filed: Jan. 26, 2009

(30) Foreign Application Priority Data
Jun. 11, 2008 (TW) 097121658

(51) Int. Cl. H04W 12/00

(52) U.S. Cl. 726/15

(57) ABSTRACT

An identity verification system applicable to a virtual private network architecture and method of the same are provided. The system is provided and connected to a virtual private network gateway. The virtual private network gateway is connected to a verification server via a network access server. The method comprises receiving an access request from a network via the virtual private network gateway, performing a process of identify verification and dynamic password verification on the access request by the verification server and via the network access server, rejecting the access request if the access request does not pass the identity verification, and authorizing the access request to access a corresponding virtual private network if the access request passes the identity verification, thereby enhancing security in accessing the virtual private network.

### BACKGROUND OF THE INVENTION

1. Field of the Invention

This invention generally relates to a remote network access system and method, and more specifically, to an identity verification system applicable to a virtual private network architecture and method of the same.

2. Description of Related Art

As human history enters the twenty-first century, network application has been getting more and more popular. Owing to the flourishing network development, network architecture and expansion has gradually changed the way of doing business. Traditional workplaces and the relation between upstream manufacturers and downstream manufacturers are to be changed inevitably due to popularity of the Internet, and virtual private network (VPN) particularly brings about revolutionary changes. Business employees are no longer limited to particular workplaces. Any place capable of connecting to business network is an applicable workplace. Keen competition between enterprises prompts the enterprises to integrate with their respective upstream manufacturers and downstream manufacturers and then operate in a network environment similar to a large business system with a view to increasing competition advantage thereof.

The aforesaid changes provides benefit of higher speed business operation, consequently increasing product value, and also imply that traditional fixed business network connection architecture is no longer able to deal with growing business demands; in addition, the Internet is expected to provide those employees on business trip and business partners with a means of accessing internal business information, therefore, wide area network architecture of business has to include virtual private network functions.

Most established business network architectures commonly feature closed private connection for the sake of security of data transmission. If data transmission cannot be secured, important business data are likely to be stolen by hackers or business rivals, and consequent damage and loss are mostly beyond recovery. Therefore, security mechanism of the virtual private network architecture is the most important part of virtual private network techniques.

The security mechanism must provide two functions, namely privacy and integrity. Privacy ensures data privacy and confidentiality, and prevents network spyware of network hacker from browsing data, wherein an encryption method is generally used to provide privacy. Integrity ensures that data is properly protected so as to protect the data from any accidental or intentional alteration in the process of transmission, and the data integrity is commonly provided by using message authentication code.

Commonly used secure transmission technique, e.g. Secure Sockets Layer (SSL) is a kind of communication security technique standard taking a ciphering/deciphering approach for communication between a web server and a browser. This kind of communication process ensures privacy and integrity of all data passing between the web server and the browser. Every web server needs a certificate in order to use the SSL technique to perform secure connection.

Once the SSL is activated on the web server, the web server will create two secret keys, namely a private key and a public key. The private key is for maintaining privacy and security. The public key is not for secrecy and is allocated in a Certificate Signing Request (CSR) file, which is a file including detailed information of subscribers, and a user has to send this CSR to a certificate authority, and then undergo a SSL certificate application process. The Certification Authority verifies detailed information of subscribers and then authorizes issuing a certificate to the subscriber, thereby enabling the web server to establish an encryption connection between the server and the browser of the subscriber. Applying the SSL technique to a VPN system enables an external subscriber to use encrypted secure connection channel established between the browser and the virtual private network gateway and then get connected to the VPN system at anywhere and anytime.

To use SSL virtual private network connection, a subscriber may access resources and programs of the virtual private network simply via a browser supported by SSL encryption protocol, so as to be free of connection restriction of network security mechanism, e.g., a firewall and others, and also entitled to support lent to apparatuses, such as person digital assistant (PDA), General Packet Radio Service (GPRS) cell phones, thereby providing the subscriber with a great deal of application flexibility; basically, as long as a web page is accessible without a hitch, open resources inside the network are also accessible smoothly, and any wanted data are obtainable at anytime and anyplace.

The aforesaid conventional SSL virtual private network allows subscribers to flexibly access resources and programs of the virtual private network via a browser, but it has the following drawbacks.

First, subscribers generally log on SSL virtual private network by means of single password verification. An excellent password security mechanism is the first protection line from intrusion, and the most common way of intrusion is to steal a subscriber's password or directly steal secret data. In a common non-dynamic single password system, an easy-to-remember password is easily broken into, while a complicated password is difficult to memorize. Once a subscriber's password for logging on the SSL virtual private network is stolen, the hacker can access important data inside the virtual private network.

Secondly, when a remote network access system is to be integrated into a plurality of virtual private networks, to avoid conflict among each virtual private network due to the same IP address, an IP address commonly has to be converted by means of Network Address Translation (NAT), therefore, IP address management is complicated and tough.

Hence, a highly urgent issue facing the industry involves providing a remote network access system with high security and method of the same, and integrating the system into a virtual private network system.

### SUMMARY OF THE INVENTION

In view of the disadvantages of the prior art mentioned above, it is a primary objective of the present invention to provide an identity verification system applicable to a virtual private network architecture and coupled to a virtual private network gateway. The identity verification system is provided with a network access server connected to the virtual private network gateway and a verification server connected to the network access server. When the virtual private network gateway receives an access request for accessing a virtual private network, it makes the verification server execute identity verification and dynamic password verification via the network access server. And, if the access request passes the identity verification and the dynamic password verification, the access request is authorized to access the virtual private network.

In another embodiment of the present invention, a firewall connected to the virtual private network gateway is further provided. The firewall is interconnected among the virtual private network gateway, the network access server, and the virtual private network. Alternatively, the firewall is connected between the virtual private network gateway and a network.

In a further embodiment of the present invention, the virtual private network comprises a plurality of virtual private network systems. Preferably, the access request includes virtual local network label added in via the virtual private network gateway, and also the virtual private network comprises a virtual local network label identification device for verifying a virtual private network system in the virtual private network system to be accessed by the access request based on the virtual local network label, thereby enabling the access request to log on the virtual private network system to be accessed for performing access process.

In still another embodiment of the present invention, the network access server is a Remote Authentication Dial In User Service (RADIUS) server, which performs identity verification, using an account number and a password.

In still another embodiment of the present invention, the identity verification system further comprises a password generator for providing a verification password to a network terminal device. In addition, the verification server is a One Time Password (OTP) verification server.

The present invention further provides an identity verification method applicable to a virtual private network architecture and to a virtual private network gateway. The virtual private network gateway is connected to the verification server via a network access server. The method comprises: first, receiving access request from network through the virtual private network gateway; next, the verification server performs a process of identity verification and dynamic password verification on the access request via the network access server, rejecting the access request if the access request does not pass the identity verification, and authorizing the access request to access a corresponding virtual private network if the access request passes the identity verification.

In another embodiment of the present, the method further comprises the steps of adding a virtual local network label to the access request via the virtual private network gateway, authorizing the access request to access a corresponding virtual private network if the access request passes the identity verification, and identifying the virtual private network in response to the access request according to the virtual local network label, thereby enabling the access request to log on the virtual private network for performing access.

Compared with the conventional remote network access device, the identity verification system and method applicable to a virtual private network architecture according to the present invention are characterized by adopting OTP dynamic password technique integrated with virtual private network gateway technique to verify subscriber identity of an access request for accessing a virtual private network. Since the most important advantage of the dynamic password is using a randomly generated password which is randomly generated for each instance, and also the password is used once only; therefore even an unauthorized person intercepts a one-time password, the one-time password cannot be applied to the next instance of logging on. Accordingly, the aforesaid identity verification system and method applicable to a virtual private network architecture according to the present invention are capable of enhancing access security of remote network and providing subscriber connection convenience.

### BRIEF DESCRIPTION OF DRAWINGS

The present invention can be better understood by reading the following detailed description of the preferred embodiments, with reference made to the accompanying drawings, wherein:

FIG. 1a is a system architecture diagram illustrating a first embodiment of an identity verification system applicable to a virtual private network architecture according to the present invention;

FIG. 1b is a flowchart illustrating the first embodiment of an identity verification method applicable to a virtual private network architecture according to the present invention;

FIG. 2a is a system architecture diagram illustrating a second embodiment of an identify verification system applicable to a virtual private network architecture according to the present invention;

FIG. 2b is a flowchart illustrating the second embodiment of an identity verification method applicable to a virtual private network architecture according to the present invention; and

FIG. 3 is a system architecture diagram illustrating a third embodiment of an identity verification system applicable to a virtual private network architecture according to the present invention.

### DETAILED DESCRIPTION OF PREFERRED EMBODIMENTS

The following illustrative embodiments are provided to illustrate the disclosure of the present invention, these and other advantages and effects can be apparently understood by persons skilled in the art after reading the disclosure of this specification. The present invention can also be performed or applied by other different embodiments. The details of the specification may be on the basis of different points and applications, and numerous modifications and variations can be devised without departing from the spirit of the present invention.

### First Embodiment

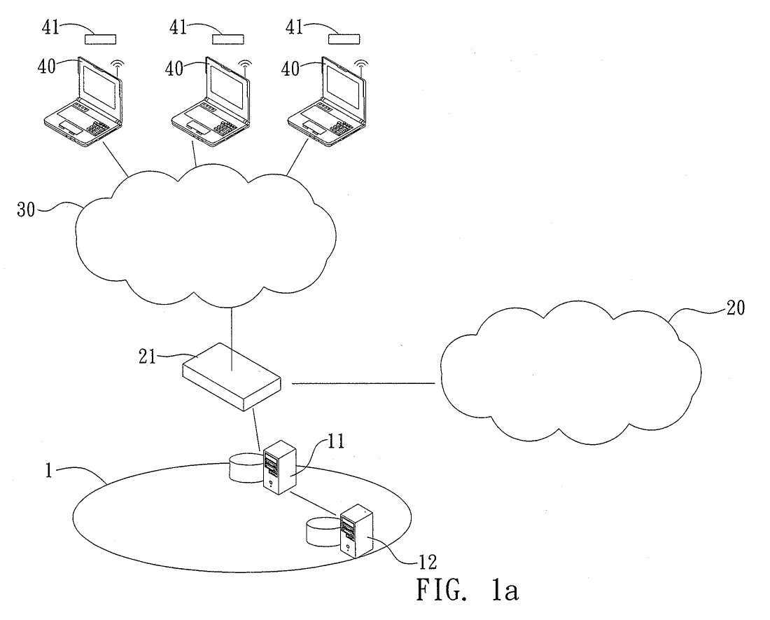

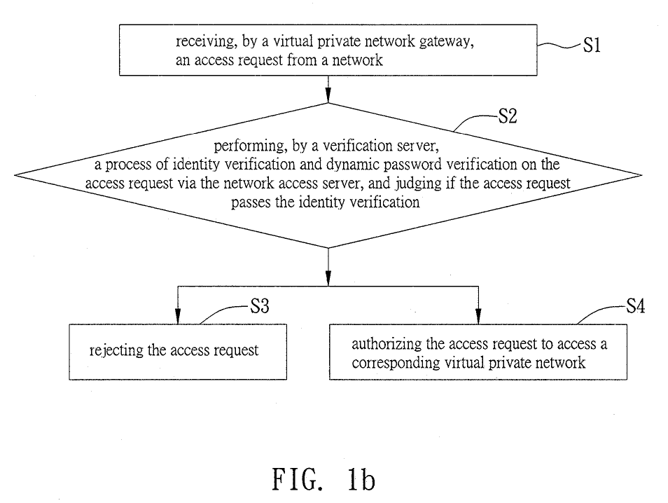

Referring to FIG. 1a, which is a system architecture diagram illustrating a first embodiment of an identity verification system applicable to a virtual private network architecture according to the present invention, the identity verification system 1 applicable to a virtual private network architecture according to the present invention is applicable to a virtual private network 20. The virtual private network 20 is connected to an external network 30 via a virtual private network gateway 21. The network 30 can be connected to network terminal devices 40. Each of the network terminal devices 40 is allocated with a password generator 41. The identity verification system 1 applicable to a virtual private network architecture according to the present invention is provided and connected to the virtual private network gateway 21.

The virtual private network 20 is for providing virtual private network services, providing those large-scale businesses, organization, or government institutions or similar organizations, which have established virtual private networks, with not only security and closeness of private internal transmission but also external connection convenience for accessing data; in the present embodiment, the virtual private network 20 is able to selectively use a hardware virtual private network and/or a software virtual private network; wherein equipment of the hardware virtual private network can be a virtual private network router (VPN Router). This kind of equipment not only saves encrypted keys in a memory, which is unlikely to get damaged, but also enables faster ciphering/deciphering speed. A product of the software virtual private network is disposed at a server and operation platform, and a virtual private network channel is established based on a destination address or a communication protocol.

In the present embodiment, Secure Sockets Layer (SSL) is applied to the network 30, and the network terminal device 40 together with the password generator 41 send out an access request. The access request is sent to the virtual private network gateway 21 via the network 30, and then goes through the virtual private network gateway 21 and the verification process performed by the identity verification system 1 applicable to a virtual private network architecture according to the present invention. The access request is able to log on the virtual private network 20 for performing the access request including browsing web pages, and transmitting or receiving data. Since the virtual private network 30 of SSL architecture is adopted, SSL techniques including SSL encryption technique can be used to establish an encryption transmission channel, and also providing greater data transmission security than conventional IPSec technique; in the present embodiment, the password generator 41 can be, e.g. a dynamic password generator, preferably, an dynamic password generator that produces One Time Password (OTP).

The network 30 is, for example, Internet, intranet, extranet, local area network (LAN), wide area network (WAN), or virtual private network (VPN), and also certainly can be any combination of the networks.

The network terminal device 40 is, for example, a workstation, server, personal computer, notebook computer, tablet personal computer, palm personal computer, mobile smart phone, mobile phone and/or personal digital assistant (PDA), and each of the terminals also comprises a web browser interface.

The network 30 can be a wired network system, a wireless network system, or a combination of the wired and wireless network systems. As mentioned earlier, any network terminal device 40 connectable to an SSL virtual private network gateway 21 via an interface of a browser falls within the scope of application of the present invention.

The identity verification system applicable to a virtual private network architecture according to the present invention comprises a network access server 11 and a verification server 12.

The network access server 11 is connected to the virtual private network gateway 21, and connecting to the virtual private network 20 and the network 30 via the virtual private network gateway 21; in the present embodiment, the network access server 11 can be a Remote Authentication Dial In User Service (RADIUS) verification server, adopting RADIUS protocol; and the verification server 12 can be a One Time Password (OTP) verification server.

The OTP verification server 12 and the RADIUS verification server 11 are connected to each other. When the virtual private network gateway 21 receives an access request for accessing the virtual private network 20, the RADIUS verification server 11 performs the process of identity verification and dynamic password verification, and then authorizes the access request to access a corresponding virtual private network after the access request passed the identity verification and dynamic password verification.

Specifically speaking, the OTP verification server 12 performs the process of identity verification on a subscriber of the network terminal device 40 that is connected to the virtual private network gateway 21 for sending out an access request for accessing the virtual private network 20. Applying a randomly generated password is the main feature of a dynamic password, and the password generated varies from instance/event to instance/event and can be used once only. The OTP verification server 12 can take many approaches to verify the subscriber identity of the network terminal device 40, for instance, the network terminal device 40 can use the password generator 41 to produce a random one time password, and the OTP verification server 12 uses a key operation method corresponding to the password generator 41. After the network terminal device 40 has received the random key generated by the password generator 41, the OTP verification server 12 calculates a key value instantly by the operation method, thereby identifying the subscriber identity of the network terminal device corresponding to the key.

Referring to FIG. 1b, which is a flowchart illustrating the first embodiment of an identity verification method applicable to a virtual private network architecture according to the present invention, in step S1, the virtual private network gateway receives an access request from a network; next, proceeding to step S2; to use a network terminal device 40 to log on a virtual private network 20 via a network 30, a subscriber gets connected to a virtual private network gateway 21, and then the virtual private network gateway 21 receives the access request of the network terminal device 40 from the network 30.

In step S2, the verification server performs the process of identity verification and dynamic password verification on the access request via the network access server, then proceeding to step S3 if the access request does not pass the identity verification, and proceeding to step S4 if the access request passes the identity verification; to get connected to the virtual private network 20 via the network terminal device 40 and to send out the access request for accessing the virtual private network 20, the subscriber has to log on by means of a browser interface; and at this moment, an encrypted data transmission channel is established between the network terminal device 40 and the virtual private network 20; and while the subscriber logging on the virtual private network 20 via the network terminal device 40, in addition to inputting an account number and a password, a set of dynamic password is also required; next, the network access server 11 transmits the set of dynamic password to the verification server 12 for performing analysis operation, if the subscriber of the network terminal device 40 is verified as an authorized identity, then proceeding to step S3; otherwise, proceeding to step S4.

In step S3, the subscriber of the network terminal device 40 does not have authorization of accessing the virtual private network 20, therefore, rejecting the access request.

In step S4, the verification server 12 instructs the network access server 11 to authorize the subscriber of the network terminal device 40 to access the virtual private network 20, namely, authorizing the access request to access a corresponding virtual private network.

### Second Embodiment

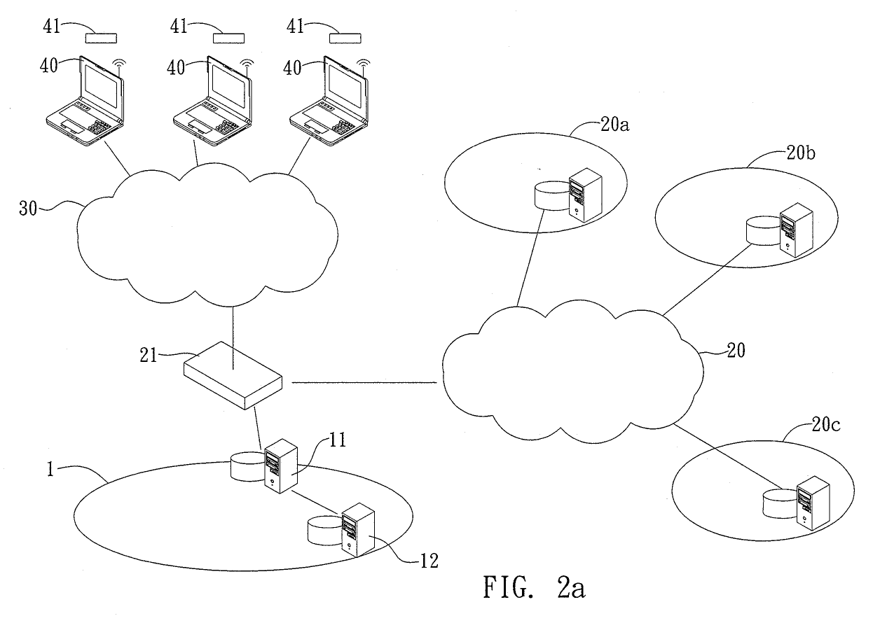

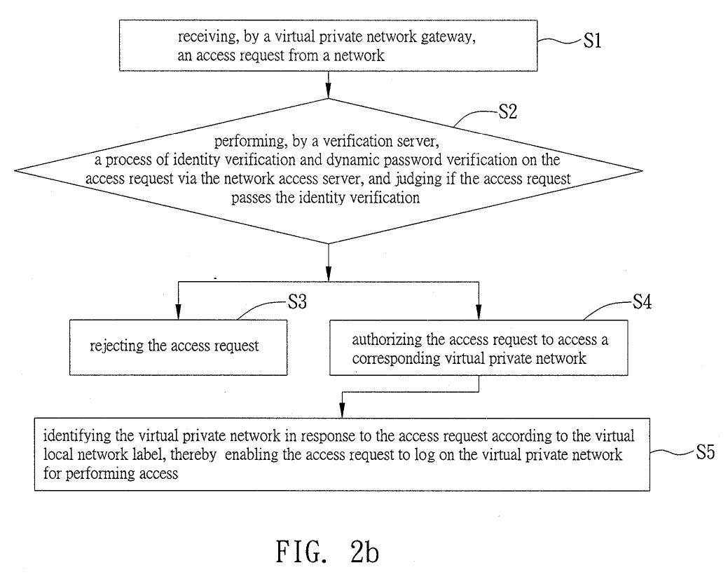

Referring to FIG. 2a, which is a system architecture diagram of a second embodiment of an identity verification system applicable to a virtual private network architecture according to the present invention, the architecture and components of the present embodiment are mostly similar to those of the first embodiment, the main difference is that the virtual private network 20 of the present embodiment comprises three virtual private network systems 20a, 20b, and 20c; in a practical application, the number of virtual private systems is not restricted.

Specifically speaking, different virtual private network systems 20a, 20b, and 20c may belong to different businesses, schools, or persons; and the virtual private network 20 itself can be established by an Internet Service Provider (ISP).

According to the stated aforesaid, since the virtual private network 20 comprises three different virtual private network systems 20a, 20b, and 20c, in order to identify each of the virtual private network systems 20a, 20b, and 20c targeted by access request sent by network terminal device 40 via network 30, can selectively add a virtual local network label to each access request, and also the virtual private network 20 further comprises a virtual local network label identification device, and then identifying the virtual private network system corresponding to the access request as 20a, 20b, or 20c based on the virtual local network label of the access request, thereby enabling the access request to log on the virtual private network system 20a, 20b, or 20b to be accessed for performing access.

Referring to FIG. 2b, which is a flowchart illustrating the second embodiment of an identity verification method applicable to a virtual private network architecture according to the present invention, in step S1, a virtual private network gateway receives an access request from a network; next, proceeding to step S2.

In step S2, a verification server performs a process of identity verification and dynamic password verification on the access request via a network access server, then proceeding to step S3 if the access request does not pass the identity verification, and proceeding to step S4 if the access request passes the identity verification.

In step S3, rejecting the access request.

In step S4, authorizing the access request to access a corresponding virtual private network, then proceeding to step S5.

In step S5, identifying the virtual private network in response to the access request according to the virtual local network label, thereby enabling the access request to log on the virtual private network system to be accessed for performing access.

### Third Embodiment

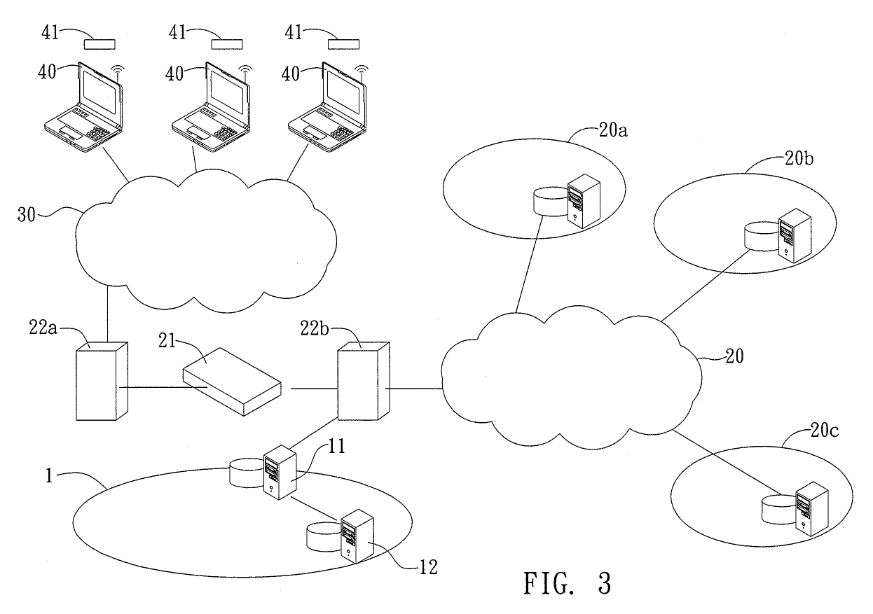

Referring to FIG. 3, which is a system architecture diagram illustrating the third embodiment of an identity verification system applicable to a virtual private network architecture according to the present invention, the present embodiment is integrable to the first or the second embodiment, and descriptions of the architecture of the second embodiment are as follows.

In the present embodiment, the identity verification system applicable to a virtual private network architecture according to the present invention can further selectively comprise firewalls 2a and/or 22b, the firewalls 22a and 22b are both connected to the virtual private network gateway 21.

More specifically, the firewall 22a is selectively connected between the virtual private network gateway 21 and the network 30; on the other hand, the firewall 22b can also be selectively interconnected among the virtual private network gateway 21, the RADIUS verification server 11, and the virtual private network 20.

Accordingly, firewalls 22a and/or 22b are security devices for separating two different networks, in the present embodiment, the firewalls are for separating the virtual private network 20 and the network 30; the firewalls enable authorized subscribers to access data inside the virtual private network 20 normally, and prevents unauthorized subscribers from causing intentional damage to data of the virtual private network 20 and protects data of the virtual private network 20; the firewalls 22a and/or 22b can be software or hardware for preventing computer virus or hackers from entering the virtual private network 20 via the network 30.

Function of the firewalls 22a and/or 22b includes but not restricted to packet filtering, proxy server, and status examination; wherein packet filtering is a simple firewall mechanism; this kind of firewall will examine on destination and origin IP addresses and TCP/UDP port of packet, and then deciding whether accepting or rejecting the packet according to simple rules preset by management; in other words, performing filtering process according to rules preset by the management, and then examining and deciding if the packet is to be rejected or is to be transmitted.

Proxy program of the proxy server located at application layer is a software executed on the firewalls 22a and/or 22b, being capable of simulating origin and destination connected to each other via the network 30; all network transmission between subscribers have to be through the proxy server for performing a process of testing on data and connection authorization, therefore in the process of testing data, being capable of effectively separating trusted virtual private network 20 from network 30; program of the proxy server examines data sent from subscriber, and then judge if the data are authorized data or not before transmitting authorized data or directly rejecting unauthorized data.

Status examination firewall uses approach similar to packet filtering for controlling network transmission, and further examining content of data packet flow, but not simply filtering packet; status examination packet firewall 22a and/or 22b perform a process of judgment filtering according to the origin IP address and destination IP address of packet and demanded service.

It should be specially stated herein, the firewalls 22a and/or 22b have various functions and types, any firewall integrable to the identity verification system and method and applicable to a virtual private network architecture according to the present invention falls in the application scope of the preset invention.

### Fourth Embodiment

In the present embodiment, an identity verification system applicable to a virtual private network architecture according to the present invention is integrable to the first, the second, or the third embodiment; more specifically, the RADIUS verification server 11 and the OTP verification server 12 can be selectively integrated into a single server device, and since integrating of the RADIUS verification server 11 and the OTP verification server 12 into a single server device is not a main feature technique of the present invention but only an embodiment of the present invention, and thus no more illustration or description is provided hereafter.

In summary, dual-factored authentication mechanism provided by the identity verification system and method applicable to a virtual private network architecture according to the present invention enhances the security of a virtual private network, and the simple architecture thereof also reduces the installation cost of a virtual private network security system, thereby enhancing the security of remote network access and facilitating subscriber connection.

In addition, upon its integration with the identity verification system and method applicable to a virtual private network architecture according to the present invention, the SSL virtual private network architecture has the following advantages: providing subscriber with a simple means, the subscriber is able to connect to internal network of virtual private network by using a browser, and there is no restriction on operation system of the subscriber; providing subscriber with a convenient means, the subscriber is capable of performing instant remote access by simply disposing SSL virtual private network gateway; and providing simplified identity verification mode.

Accordingly, the identity verification system and method applicable to a virtual private network architecture according to the present invention effectively enhance the security of remote network access, facilitate subscriber connection, and reduce the installation cost incurred by virtual private network subscribers.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. An identity verification system applicable to a virtual private network architecture and coupled to a virtual private network gateway, the identity verification system comprising:
a network access server connected to the virtual private network gateway; and
a verification server connected to the network access server and configured to perform a process of identity verification and dynamic password verification via the network access server when the virtual private network gateway receives an access request for accessing a virtual private network, and further configured to authorize the access request to access the virtual private network after the access request passes the identity verification and the dynamic password verification.

2. The system of claim 1, further comprising a firewall connected to the virtual private network gateway.

3. The system of claim 2, wherein the firewall is interconnected among the virtual private network gateway, the network access server, and the virtual private network.

4. The system of claim 2, wherein the firewall is connected between the virtual private network gateway and a network.

5. The system of claim 4, wherein the network comprises at least one selected from the group consisting of Internet, intranet, extranet, local area network system, wide area network system, and virtual private network system.

6. The system of claim 4, wherein the network is at least one of a wired network system and a wireless network system.

7. The system of claim 4, wherein the network is connected to network terminal devices.

8. The system of claim 7, wherein the network terminal devices comprise at least one selected from the group consisting of workstation, server, personal computer, notebook computer, tablet personal computer, palm personal computer, mobile smart phone, mobile phone, and personal digital assistant.

9. The system of claim 7, further comprising a password generator for providing a verification password to the network terminal devices.

10. The system of claim 7, wherein the password generator is a dynamic password generator.

11. The system of claim 1, wherein the virtual private network comprises a plurality of virtual private network systems.

12. The system of claim 11, wherein the access request includes a virtual local network label, and the virtual private network comprises a virtual local network label identification device for identifying a virtual private network system in the virtual private network to be accessed by the access request based on the virtual local network label, thereby enabling the access request to log on the virtual private network system to be accessed for performing access.

13. The system of claim 1, wherein the virtual private network is at least one of a hardware virtual private network and a software virtual private network.

14. The system of claim 1, wherein the network access server performs the process of identity verification by using an account number and a password.

15. The system of claim 14, wherein the network access server is a Remote Authentication Dial In User Service (RADIUS) verification server.

16. The system of claim 1, wherein the verification server is a One Time Password (OTP) verification server.

17. The system of claim 1, wherein the network access server and the verification server are integrated into a single server device.

18. An identity verification method applicable to a virtual private network architecture and coupled to a virtual private network gateway, wherein the virtual private network gateway is connected to a verification server via a network access server, the method comprising the steps of:
(1) receiving, by the virtual private network gateway, an access request from a network;
(2) performing, by the verification server, a process of identity verification and dynamic password verification on the access request via the network access server, then proceeding to step (3) if the access request does not pass the identity verification, and proceeding to step (4) if the access request passes the identity verification;
(3) rejecting the access request; and
(4) authorizing the access request to access a corresponding virtual private network.

19. The method of claim 18, wherein the access request includes a virtual local network label, and the step (4) further comprises the step of:
(5) identifying the virtual private network in response to the access request according to the virtual local network label, thereby enabling the access request to log on the virtual private network for performing access.

20. The method of claim 18, wherein the virtual private network gateway is connected to the firewall.

21. The method of claim 20, wherein the firewall is interconnected among the virtual private network gateway, the network access server, and the virtual private network.

22. The method of claim 20, wherein the firewall is connected between the virtual private network gateway and the network.

23. The method of claim 18, wherein the network comprises at least one selected from the group consisting of Internet, intranet, extranet, local area network system, wide area network system, and virtual private network system.

24. The method of claim 18, wherein the network is at least one of a wired network system and a wireless network system.

25. The method of claim 18, wherein the network is connected to network terminal devices.

26. The method of claim 25, wherein the network terminal devices comprise at least one selected from the group consisting of workstation, server, personal computer, notebook computer, tablet personal computer, palm personal computer, mobile smart phone, mobile phone, and personal digital assistant.

27. The method of claim 18, wherein the virtual private network comprises a plurality of virtual private network systems.

28. The method of claim 18, wherein the virtual private network is at least one of a hardware virtual private network and a software virtual private network.

29. The method of claim 18, wherein the network access server performs the process of identity verification by using an account number and a password.

30. The method of claim 18, wherein the network access server is a Remote Authentication Dial In User Service (RADIUS) verification server.

31. The method of claim 18, wherein the verification server is a One Time Password (OTP) verification server.
